(19) United States
(12) Patent Application Publication
(10) Pub. No.: US 2020/0264433 A1
(43) Pub. Date: Aug. 20, 2020

(54) AUGMENTED REALITY DISPLAY DEVICE AND INTERACTION METHOD USING THE AUGMENTED REALITY DISPLAY DEVICE

(71) Applicant: Hangzhou Rongmeng Smart Technology Co., Ltd., Hangzhou (CN)

(72) Inventors: Zhangyi Zhong, Guangdong (CN); Ying Mao, Guangdong (CN)

(21) Appl. No.: 16/508,181

(22) Filed: Jul. 10, 2019

(30) Foreign Application Priority Data
Feb. 18, 2019 (CN) 201811576069.3

(51) Int. Cl. G02B 27/01; G06F 3/01

(52) U.S. Cl. CPC G02B 27/0172; G06F 3/011; G02B 2027/014; G02B 2027/0187; G02B 2027/0178

(57) ABSTRACT

The present invention relates to augmented reality, and in particular, relates to an augmented reality display device. The display device includes: a device body, configured for a user to wear the display device; a transparent lens portion, configured for the user to see a real environment picture when wearing, at least a portion of a region of the transparent lens portion being a display region; a wireless transmission module, configured to receive virtual image information from the smart mobile terminal; and a processor, configured to process the virtual image information and display a corresponding virtual image picture, such that the virtual image picture is superimposed on a real environment picture.

### CROSS-REFERENCE TO RELATED APPLICATION(S)

This application claims priority of the Chinese Patent Application Ser. No. 201811576069.3, filed Feb. 18, 2019 and titled, “AUGMENTED REALITY DISPLAY DEVICE AND INTERACTION METHOD USING THE AUGMENTED REALITY DISPLAY DEVICE,” which is also hereby incorporated by reference in its entirety for all purposes.

### TECHNICAL FIELD

The present invention relates to the technical field of augmented reality, and in particular, relates to an augmented reality display device, and an interaction method for generating context-based augmented reality content.

### BACKGROUND

Portability of electronic devices (such as cell phones, tablets, game consoles or computers) is always in conflict with their actual screen size. For example, mobile phones' screens are usually less than 6-inch, and portable laptop screens are usually less than 17 inches. Users often improve the viewing experience by connecting to large-screen displays (for example, large-screen computers) that include a video processing capabilities.

For an enhanced watch experience for the users, there are some fully-closed VR devices, for example, VR glasses for cooperative use with the game players released by SONY®. Such VR devices provide 3D-fashioned pictures for the users. However, for realization of a 3D effect, the users need to be absolutely isolated from an ambient environment when wearing or using such VR devices, the users can fail to perceive or acknowledge conditions or variations of the ambient environment, and consequently a series of problems are caused. For example, problems of safety or vertigo are caused.

### SUMMARY

Embodiments of the present invention solve the technical problem that a conventional display device is heavy and inconvenient to carry.

To solve the above technical problems, embodiments of the present invention provide the following technical solutions:

In a first aspect, some embodiments of the present invention provide an augmented reality display device. The augmented reality display device includes: a device body, which is configured for a user to wear the display device; a transparent lens portion, the transparent lens portion being connected with the device body such that a real environment picture is observed by users when wearing the display device, at least a portion of a region of the transparent lens portion being a display region; a wireless transmission module, the wireless transmission module being fixed on the device body, establishing a wireless communication connection with the intelligent mobile terminal for receiving virtual image information from the intelligent mobile terminal; and a processor, the processor being received in the device body, and configured to process the virtual image information and display a corresponding virtual image picture on the display region.

In some embodiments, the display region includes a left-side display region corresponding to a left eye vision of the user and a right-side display region corresponding to a right eye vision of the user.

In some embodiments, the virtual image information is configured to achieve a virtual picture of the left-eye and the right-eye; and the processor is specifically configured to control the left-side display region to display the left-eye virtual picture and control the right-side display region to display the right-eye virtual picture, to achieve a 3D effect.

In some embodiments, the processor includes a virtual image information conversion module and a display control module; wherein the virtual image conversion module is configured to generate the left-eye virtual picture and the right-eye virtual picture based on the virtual image information; and the display control module is configured to control the left-side display region to display the left-eye virtual picture and control the right-side display region to display the right-eye virtual picture, to achieve a 3D effect.

In some embodiments, the processor is specifically configured to display the same virtual image picture on the left-side display region and the right-side display region, which can be used to create the 3D effect in some cases.

In some embodiments, the virtual image information is virtual image information locally stored by the smart mobile terminal, or online virtual image information acquired by the smart mobile terminal over a network, or screen information of the smart mobile terminal.

In some embodiments, the display device further includes an attitude sensor configured to acquire posture information; wherein the processor is connected to the attitude sensor, and is configured to adjust the virtual picture based on the posture information to maintain a relative position relationship with the head of the user unchanged; and the attitude sensor includes a gyroscope, an accelerometer and a magnetometer.

In a second aspect, some embodiments of the present invention provide an interaction method of the augmented reality display device. The method includes: acquiring one or more user interactive actions by using a smart mobile terminal; parsing the interactive action to acquire the corresponding operation instructions; and performing a corresponding operation for virtual image information based on the operation instruction.

In some embodiments, the operation instructions include reducing, enlarging and rotating one or more target objects in the virtual image information.

In some embodiments, the method further includes: acquiring, by the smart mobile terminal, current position information of a user and a destination position input; planning a corresponding movement route based on the current position information and the destination position; the route and location information determine a movement direction; and the direction of the movement is displayed on a display region of the augmented reality display device in a fashion of a pointing arrow.

In some embodiments, the method further includes: adjusting a transmittance of a transparent lens portion based on a current environment luminance.

With the augmented reality display device according to the embodiments of the present invention, video information from a smart mobile terminal can be received by a wireless transmission module, such that the user does not need to carry a bulky large-screen display, but only wears the augmented reality display device to achieve a 2D or 3D effect. In addition, it is convenient to carry, and since the augmented reality display device is not isolated from an ambient environment, the security is higher than that of the traditional VR device.

With the augmented reality display device according to the present invention, video information from a smart mobile terminal can be received by a wireless transmission module, such that the user does not need to carry a bulky large-screen display on the way of commuting or shopping, but only needs to simply wear the augmented reality display device to achieve a 3D effect. In addition, since the augmented reality display device is not isolated from an ambient environment, and thus achieves higher security relative to a traditional VR device.

### BRIEF DESCRIPTION OF THE DRAWINGS

One or more embodiments are illustrated by means of images, and not by limitation, in the figures of the accompanying drawings, wherein components having the same reference numeral designations represent like components throughout. The drawings are not to scale, unless otherwise disclosed.

FIG. 1 is a schematic diagram of an application scenario according to an embodiment of the present invention;

FIG. 2 is a schematic structural diagram of an augmented reality display device according to an embodiment of the present invention;

FIG. 3 is a schematic block diagram of an augmented reality display device according to an embodiment of the present invention;

FIG. 4 is a schematic flowchart of an interaction method using the augmented reality display device according to an embodiment of the present invention; and

FIG. 5 is a schematic flowchart of another interaction method using the augmented reality display device according to an embodiment of the present invention.

### DETAILED DESCRIPTION

For clear descriptions of objectives, technical solutions, and advantages of the present invention, the present invention is further described in detail below by reference to the embodiments and the accompanying drawings. It should be understood that the specific embodiments described herein are only intended to explain the present invention instead of limiting the present invention.

It should be noted that, in the absence of conflict, embodiments of the present invention and features in the embodiments can be incorporated, which all fall within the protection scope of the present invention. In addition, although logic function module division is illustrated in the schematic diagrams of apparatuses, and logic sequences are illustrated in the flowcharts, in some occasions, steps illustrated or described by using modules different from the module division in the apparatuses or in sequences different from those illustrated. Further, terms “first”, “second” and the like used herein in the present application are not intended to limit the data and sequence of performing the steps, but are only intended to distinguish identical items or similar items having the substantially identical function or effect.

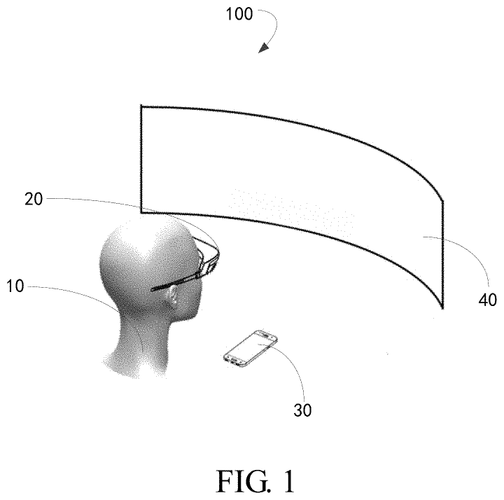

Referring to FIG. 1, FIG. is a schematic diagram of an application scenario according to an embodiment of the present invention. As illustrated in FIG. 1, the application scenario includes: a user 10, an augmented reality display device 20 and a smart mobile terminal 30.

Then augmented reality display device 20 is a device having an optical synthesis device and implementing a projection display function, which can establish a wireless communication connection with the separated smart mobile terminal 30. In FIG. 1, a head-mounted augmented reality (AR) display is taken as an example for presentation.

When the user wears the head-mounted AR display, in one aspect, the portion of the light from a real environment is seen by the eyes of the user via a semi-transparent reflective mirror. In another aspect, virtual image information on the smart mobile terminal 30 is projected on a portion of a region of the semi-transparent reflective mirror through the head-mounted AR display, such that virtual image information of the smart mobile terminal 30 is reflected to the eyes of the user via the surface of the semi-transparent reflective mirror. The semi-transparent reflective mirror is equivalent to a virtual screen 40 in FIG. 1. When the user 10 wears the head-mounted AR display, a current picture of the separated smart mobile terminal 30 can be seen on the virtual screen 40.

Specifically, a transmittance of the semi-transparent reflective mirror is able to be adjusted based on a current ambient environment, which is able to be adjusted through the smart mobile terminal 30 or augmented reality display device 20. For example, a luminance of the ambient environment is able to be acquired, and the transmittance of the semi-transparent reflective mirror is able to be adjusted and modified to obtain an optimal watch experience.

In this embodiment, a design/structural construction separated from a processing part (e.g., the smart mobile terminal) is used. The separated smart mobile terminal 30 outputs the virtual image information such as videos and the like to the augmented reality display device 20 in a wireless transmission method. This makes the augmented reality display device 20 lighter than a large-size tablet display, and thus an immersive display experience and great portability is provided. In another aspect, when the user operates the augmented reality display device 20, since the real environment is seen, the user is able to timely acknowledge the ambient environment while using the augmented reality display device 20, and can response to any event that needs attention in time, thereby ensuring safety of the user.

Hereinafter, the specific structure and application principle of the augmented reality display device 20 are firstly elaborated. For ease of understanding, in the embodiments of the present invention, image information acquired from the separated smart mobile terminal 30 that the user needs to watch is defined as virtual image information. The virtual image information can be image information locally stored by the smart mobile terminal, or can be online virtual image information acquired by the smart mobile terminal over a network, which can be any suitable image information in the smart mobile terminal 30, for example, videos, photos and the like. As such, the augmented reality display device 20 can acquire the virtual image information in real time, and the user can achieve the 2D or 3D effect by using the augmented reality display device 20.

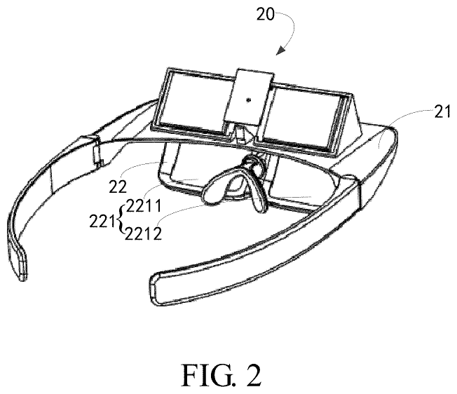

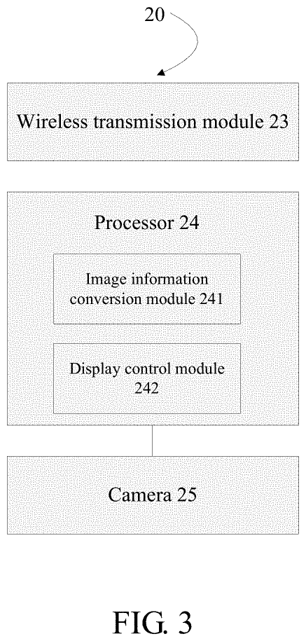

Referring to FIG. 2 and FIG. 3, FIG. 2 is a schematic structural diagram of an augmented reality display device 20 according to an embodiment of the present invention; and FIG. 3 is a schematic block diagram of an augmented reality display device 20 according to an embodiment of the present invention. As illustrated in FIG. 2 and FIG. 3, the augmented reality display device 20 includes: a device body 21, a transparent lens portion 22, a wireless transmission module 23 and a processor 24.

The device body 21 serves as a supporting body of the augmented reality display device 20 for the user to wear to provide corresponding support.

The transparent lens portion 22 is connected to the device body 21, such that the user can see a real environment picture via reflection of the transparent lens portion 22 when the augmented reality display device 20 is worn.

At least a portion of a region of transparent lens portion 22 is a display region 221, wherein the display region 221 is configured to display a picture transmitted from the separated smart mobile terminal.

Specifically, the display region 221 includes a left-side display region 2211 corresponding to a left eye vision of the user and a right-side display region 2212 corresponding to a right eye vision of the user, wherein these two display regions can display the same or different images from the smart mobile terminal 30. When these two display regions display the same image, a 2D experience can be achieved; and when these two display region respectively display different images, a 3D experience can be achieved based on a parallax between the left eye and the right eye.

The wireless transmission module 23 (FIG. 3) is fixed to the device body 21, and can establish a wireless communication connection with the smart mobile terminal 30 to receive virtual image information from the smart mobile terminal 30.

The augmented reality display device 20 and the smart mobile terminal 30 can be connected to the same wireless channel to establish the wireless communication connection.

For example, the user sets the smart mobile terminal 30 to be in a wireless router mode, such that a local area network is provided. The wireless transmission module 23 of the augmented reality display device 20 can be connected to the local area network, and acquire the smart mobile terminal 30 corresponding to the local area network, to carry out data communication between the augmented reality display device 20 and the smart mobile terminal 30.

In some other embodiments, the user can also connect the augmented reality display device 20 to a local area network via a WiFi device. That is, the user selects a WiFi device, and the wireless transmission module 23 of the augmented reality display device 20 can be simultaneously connected to the selected local area network, that is, the augmented reality display device 20 acquires the smart mobile terminal 30 corresponding to the local area network, and then establishes the wireless communication connection with the smart mobile terminal 30.

In still some other embodiments, the augmented reality display device 20 can also serve as a slave device, and can be connected to or added to a local area network or a hotspot established by the smart mobile terminal 30.

The wireless transmission module 23 can be any suitable type of hardware functional module that is capable of implementing the wireless communication connection, including, but not limited to, a WiFi module, a ZigBee module, a Bluetooth module and the like, as long as the requirements on bandwidth and rate of data transmission are accommodated. The wireless transmission module 23 can operate in any suitable frequency band, including, but not limited to, 2.4 GHz, 5 GHz.

The processor 24 is received in the device body 21, which is a core unit of the augmented reality display device 20 and has certain arithmetic processing capabilities. In this embodiment, the processor 24 can process the virtual image information and display the corresponding virtual image picture on the display region 221, such that the virtual image picture is superimposed on the real environment picture.

In some embodiments, the display region 221 is divided into two parts, the left-side display region 2211 and the right-side display region 2212, which respectively correspond to the left eye and the right eye of the user.

When a 2D picture needs to be displayed, the augmented reality display device 20 can acquire a piece of complete image information from the separated smart mobile terminal 30, and perform necessary distortion correction and the like for the image information, such that the same virtual image picture is displayed in the left-side display region and the right-side display region. In this way, the 2D picture is provided for the user.

When a 3D picture needs to be displayed, different virtual pictures can be respectively displayed in the left-side display region 2211 and the right-side display region 2212, and the 3D display effect is provided for the user based on a parallax between two virtual pictures. That is, the left-eye virtual picture and the right-eye virtual picture need to have different pictures having the parallax.

Specifically, when the processor 24 receives the common virtual image information from the smart mobile terminal 30, the virtual image information can be processed to obtain different left-eye virtual pictures and right-eye virtual pictures. As illustrated in FIG. 3, in this embodiment, the processor 24 can include a virtual image information conversion module 241 and a display control module 242.

The virtual image information conversion module 241 is configured to generate the left-eye virtual picture and the right-eye virtual picture based on the virtual image information; and the display control module 242 is configured to control the left-side display region to display the left-eye virtual picture and control the right-side display region to display the right-eye virtual picture, to achieve a 3D effect.

Preferably, the augmented reality display device 20 can further include an attitude sensor configured to acquire posture information.

The processor 24 is connected to the attitude sensor, and is configured to determine a head movement state and a specific posture and the like of a current user based on the posture information, and adjust the virtual picture based on the head movement state and the specific posture to maintain a relative position relationship between the virtual picture and the head of the user unchanged.

The attitude sensor can be specifically one or more sensors of any suitable type, which cooperate with each other to acquire rotation of the head of the user. For example, the attitude sensor can include, but not limited to, a gyroscope, an accelerometer and a magnetometer.

Nevertheless, in other embodiments, the image processing steps performed by the virtual image information conversion module 241 can also be performed by the smart mobile terminal 30 having the computing capability; the smart mobile terminal 30 first process the virtual image information and after the left-eye virtual picture and the right-eye virtual picture are generated, the left-eye virtual picture and the right-eye virtual picture are transmitted to the processor 24.

Correspondingly, the processor 24 is further configured to control the left-eye display region to display the left-eye virtual picture and control the right-eye display region to display the right-eye virtual picture, to achieve a 3D effect.

It should be noted that the augmented reality display device 20 can be additionally provided with one or more different hardware functional modules based on actual needs, to implement more intelligent functions. For example, in some embodiments, as illustrated in FIG. 3, the augmented reality display device 20 is further mounted with a camera 25. The camera 25 is connected to the processor 24. The camera 25 (not illustrated in FIG. 2) is arranged on the same side with the face of the user. When the user wears the augmented reality display device 20, the camera 25 can capture an operation of the smart mobile terminal 30 by the user to acquire an operation instruction of the virtual image information from the user, and implement smart control of the virtual picture.

The smart mobile terminal 30 of the embodiments of the present invention can be any suitable type, and having a user interaction apparatus, a processor having an operation capability and a wireless transmission module, for example, a mobile smart phone, a tablet computer, a smart wearable device or the like. The smart mobile terminal 30 supports installation of various of desktop applications, for example, an instant messaging application, a telephone application, a video application, an e-mail application, a digital video recorder application or the like. The augmented reality display device 20 can receive image data of videos, files and the like related to the above applications in separated the smart mobile terminal 30, and display it in a 2D or 3D effect.

The augmented reality display device and the smart mobile terminal according to the present invention can be connected and interacted by means of wireless. Since the augmented reality display device can be portable, it is convenient and private, and the user can experience better

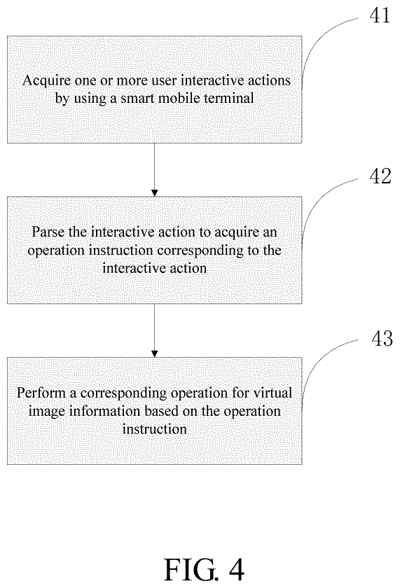

An embodiment of the present invention further provides an interaction method using the augmented reality display device. As illustrated in FIG. 4, the method includes the following steps:

One or more user interactive actions are acquired by using a smart mobile terminal.

The “interactive action” is an action triggered by a user to control the augmented reality display device 20. By using the smart mobile terminal 30, the user can adjust a virtual image displayed on the augmented reality display device 20 to obtain an adjusted image.

The interactive action is parsed to acquire an operation instruction corresponding to the interactive action.

Each interactive action has a corresponding operation. The operation can be a soft operation or a hard operation. The soft operation can be outputting a trigger signal by the smart mobile terminal based on a predetermined logic. The hard operation can be operating relevant hardware by an external device to the smart mobile terminal such that the smart mobile terminal issues an operation instruction.

For example, the interactive action is a touch operation performed by the user on the touch screen of the smart mobile terminal, which can be an operation performed with a key of the terminal, or can be operated by shaking the smart mobile terminal or rotating the smart mobile phone or the like.

A corresponding operation is performed for virtual image information based on the operation instruction.

Preferably, the operation instructions include reducing, enlarging and rotating one or more target objects in the virtual image information; and the operation instruction can also be relevant instructions for adjusting the position, size, color and the like of the virtual image.

For example, when the user wears the augmented reality display device to watch a movie, the user can input a relevant interactive action on the smart mobile terminal to control enlargement, reduction and the like of screen of the movie. In this way, image interaction can be enhanced by using the smart mobile terminal, such that the interaction modes can be enriched, and interests are increased.

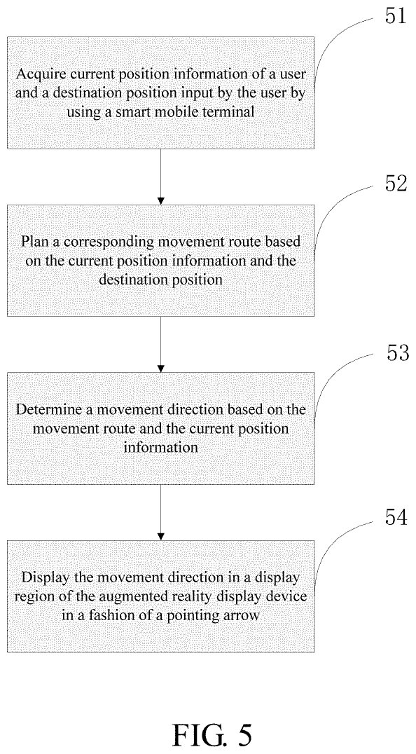

The augmented reality display device and the interaction method according to the embodiments of the present invention can be applied in various different scenarios, and provide convenient and smart user experience. Hereinafter, with reference to the method steps in FIG. 5, application of the augmented reality display device 20 in a navigation environment is described hereinafter.

In this embodiment, the smart mobile terminal 30 can be run with navigation software, for example, AMAP, Baidu Map or the like, and can be provided with a positioning hardware device configured to the current position of the user. Referring to FIG. 5, FIG. 5 is a schematic flowchart of an interaction method using the augmented reality display device according to another embodiment of the present invention. As illustrated in FIG. 5, the interaction method using the augmented reality display device includes the following steps:

Current position information of a user and a destination position input by the user are acquired by using a smart mobile terminal.

After the user starts a navigation or map software application, a search box or any other suitable option is provided for the user to input a destination. In some embodiments, the user can also input the destination position on the smart mobile terminal via acoustic control or gesture operations or the like, which specifically depends on the interaction device configured on the smart mobile terminal.

A corresponding movement route is planned based on the current position information and the destination position.

The smart mobile terminal can provide one or more movement routes to reach the destination for the user based on the map information thereof. The specific practice is a common technical means in the art, which is not described herein any further.

A movement direction is determined based on the movement route and the current position information.

Similar to daily application of the navigation software, the smart mobile terminal can determine the orientation of the user by using a gyroscope or magnetometer or the like hardware device. Afterwards, the movement route, the position information, the user orientation and the like are superimposed and computed to determine the movement direction of the user in a current state, such that a correct movement route is provided for the user.

The movement direction is displayed on a display region of the augmented reality display device in a method of a pointing arrow.

After the movement direction is computed and determined, the smart mobile terminal can use the movement direction as a virtual image and provide it to the augmented reality display device and display it on the display region thereof.

A specific pattern of the pointing arrow can be defined or adjusted based on preferences of the user or the actual needs. For example, the size, color or 3D pattern display of the arrow can be modified.

In the embodiments of the present invention, since the user can also visually observe a real-scene image with the eyes by using the augmented reality display device. Therefore, after the movement direction is superimposed and displayed, the user can observe the current road condition including the movement direction on the augmented reality display device, such that guide by the navigation software can be visually and clearly given.

As compared with conventional navigation software, in one aspect, since the augmented reality display device can be a portable head-mounted device with no limitation of connection cables, observation or sensing by the user against the ambient environment can not be affected. Therefore, when the user uses the navigation software, specific information of the planned route can be acquired when user's attention is always placed on the current road condition.

In another aspect, such a visual observation fashion simplifies understanding of the planned route provided by the navigation software. As compared with voice navigation or other navigation manners, the guide for the user is more visual, which facilitates improvements of user experience and response speed.

With respect to some transportation means having a high movement speed, for example, automobiles, bicycles or the like, such navigation interaction fashion achieves the technical effect of concentrating driver's attention, and better improves driving safety.

The above described apparatus or device embodiments are merely illustrative. The modules and units which are described as separate components can or cannot be physically separated, and the components which are illustrated as modules and units can be or cannot be physical modules and units, that is, the components can be located in the same position or can be distributed into a plurality of network modules and units. A part or all of the modules can be selected according to the actual needs to achieve the objectives of the technical solutions of the embodiments.

According to the above embodiments of the present invention, a person skilled in the art can clearly understand that the embodiments of the present invention can be implemented by means of hardware or by means of software plus a necessary general hardware platform. Based on such understanding, portions of the technical solutions of the present application that essentially contribute to the related art can be embodied in the form of a software product, the computer software product can be stored in a storage medium, such as a ROM/RAM, a magnetic disk, a CD-ROM and the like, including several instructions for causing a computer device (a personal computer, a server, or a network device) to perform the various embodiments of the present application, or certain portions of the method of the embodiments.

In utilization, the augmented reality system disclosed herein can be used to display an image/video providing a user a full screen experience. In other words, the displayed image is able to cover all or substantial all of the visual field of a user, which provides a full immerse viewing experience.

In operation, the augmented reality image is generated in a mobile device wirelessly connected to the display headset, and a synthesized image is displayed into the left and right side of the display to generate a full screen experience.

It should be noted that the above embodiments are merely used to illustrate the technical solutions of the present invention rather than limiting thereto. Under the concept of the present invention, the technical features of the above embodiments or other different embodiments can also be combined, the steps therein can be performed in any sequence, and various variations can be derived in different aspects of the present invention, which are not detailed herein for brevity of description. Although the present invention is described in detail with reference to the above embodiments, persons of ordinary skill in the art should understand that they can still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present invention.

What is claimed is:

1. An augmented reality display device, comprising:
a device body, wherein the device body is configured for a user to wear a display device;
a transparent lens portion, wherein the transparent lens portion is connected to the device body such that a real environment picture is observed when wearing the display device, wherein at least a portion of a region of the transparent lens portion is a display region;
a wireless transmission module, wherein the wireless transmission module is fixed to the device body; and a wireless communication is connected to a smart mobile terminal and is configured to receive virtual image information from the smart mobile terminal; and
a processor, wherein the processor is in the device body and is configured to process the virtual image information and display a corresponding virtual image picture on the display region.

2. The augmented reality display device according to claim 1, wherein the display region comprises a left-side display region corresponding to a left eye vision of the user and a right-side display region corresponding to a right eye vision of the user.

3. The augmented reality display device according to claim 1, wherein the virtual image information is configured to form a left-eye virtual picture and a right-eye virtual picture; and
the processor is further configured to control the left-side display region to display the left-eye virtual picture and control the right-side display region to display the right-eye virtual picture to achieve a 3D effect.

4. The augmented reality display device according to claim 1, wherein the processor comprises a virtual image information conversion module and a display control module;
wherein the virtual image conversion module is configured to generate the left-eye virtual picture and the right-eye virtual picture based on the virtual image information;
wherein the display control module is configured to control the left-side display region to display the left-eye virtual picture and control the right-side display region to display the right-eye virtual picture to achieve a 3D effect.

5. The augmented reality display device according to claim 1, wherein the processor is specifically configured to display the same virtual image picture on the left-side display region and the right-side display region.

6. The augmented reality display device according to claim 1, wherein the virtual image information is locally stored on the smart mobile terminal, is online virtual image information acquired by the smart mobile terminal over a network, or is screen information of the smart mobile terminal.

7. The augmented reality display device according to claim 1, wherein the display device further comprises an attitude sensor configured to acquire posture information;
wherein the processor is connected to the attitude sensor and configured to adjust the virtual picture based on the posture information to maintain a relative position relationship with the head of the user unchanged, wherein the attitude sensor comprises a gyroscope, an accelerometer and a magnetometer.

8. An interaction method using an augmented reality display device comprising:
acquiring one or more user interactive actions by using a smart mobile terminal;
parsing the interactive actions to acquire an operational instruction corresponding to the interactive actions; and
performing a corresponding operation for virtual image information based on the operational instruction.

9. The interaction method according to claim 8, wherein the operational instruction comprises reducing, enlarging and rotating one or more target objects in the virtual image information.

10. The interaction method according to claim 8, further comprising:
acquiring current position information of a user and a destination position input by the user by using a smart mobile terminal;
planning a corresponding movement route based on the current position information and the destination position;
determining a movement direction based on the corresponding movement route and the current position information; and
displaying the movement direction in a display region of the augmented reality display device in a fashion of a pointing arrow.

11. The interaction method according to claim 8, further comprising: adjusting a transmittance of a transparent lens portion based on a current environment luminance.
